(19) United States
(12) Patent Application Publication
(10) Pub. No.: US 2015/0285367 A1
(43) Pub. Date: Oct. 8, 2015

(54) ADAPTER MODULE

(71) Applicant: SIEMENS AKTIENGESELLSCHAFT, 80333 München (DE)

(72) Inventors: Georg Boeing, Rottenburg (DE); Wolfgang Schnurr, 72147 Nehren (DE)

(73) Assignee: SIEMENS AKTIENGESELLSCHAFT, 80333 München (DE)

(21) Appl. No.: 14/646,864

(22) PCT Filed: Nov. 25, 2013
(86) PCT No.: PCT/EP2013/074536

§ 371 Date: May 22, 2015

(30) Foreign Application Priority Data
Nov. 26, 2012 (EP) 12194252.8

(51) Int. Cl. F16H 57/025; F16H 57/04

(52) U.S. Cl. CPC F16H 57/025; F16H 57/0464; F16H 57/0471

(57) ABSTRACT

An adapter module for connecting a transmission unit and an engine unit-includes a transmission-sided adapter with a transmission-sided bearing, an engine-sided adapter which is connected to the transmission-sided adapter and which has an engine-sided bearing, an adapter shaft which is rotatably mounted in the bearings and at least one lubrication chamber for receiving lubricants and which extends annularly about the adapter shaft. The lubrication chamber is connected to the transmission-sided bearing and/or the engine-sided bearing for supplying the lubricant from the lubrication chamber to the transmission-sided bearing or the engine-sided bearing. A respective lubricant seal surrounding the adapter shaft for sealing the lubricant chamber is arranged on the transmission-side of the transmission-sided bearing and on the engine-side of the engine-sided bearing.

The invention relates to an adapter assembly for connecting a transmission unit to a motor unit, a modular system, and a method for manufacturing an adapter assembly.

In order to allow connection of a motor unit and a transmission unit, it is often necessary to arrange an adapter assembly between the two units, particularly when motors and transmissions from different manufacturers are combined, wherein said adapter unit adapts the respective interfaces of the two units to each other and connects them together in a non-rotatable manner via an adapter shaft. Such an adapter for connecting an electric motor to a transmission is disclosed in DE-A-196 37 361 (SEW Eurodrive) 26 Mar. 1998 and in U.S. Pat. No. 5,934,156 (Phillips Allyn E.) 10 Aug. 1999, wherein the latter document is considered to be the closest prior art.

In this case, the adapter shaft of the adapter assembly is usually rotatably supported in individual bearings, preferably rolling bearings. In order to reduce friction in these bearings, use is customarily made of enclosed bearings with lifetime lubrication, e.g. 2Z rolling bearings. The lifetime of the rolling bearings is limited by the lifetime of the lubricant. Once the maximum lifetime of the lubricant in the bearings has been reached, the lubricant or the bearings must be replaced, resulting in maintenance costs and lengthy downtimes, and possibly in associated production stoppage.

Alternatively, it is also customary to provide means of relubrication with grease. The relubrication with grease is usually a manual operation which must take place at regular intervals. The planning, organization and performance of such manual lubrication tasks, which must be repeated periodically, is associated with considerable expense. Moreover, the accessibility of the adapter assembly may be restricted.

The object of the present invention is therefore to provide an improved adapter assembly.

The object is achieved by an adapter assembly for connecting a transmission unit to a motor unit, comprising a transmission-side adapter with a transmission-side bearing, a motor-side adapter with a motor-side bearing, said motor-side adapter being connected to the transmission-side adapter, an adapter shaft which is rotatably supported in the bearings, and at least one lubricant chamber which extends annularly around the adapter shaft and is provided for the purpose of holding lubricant, wherein the lubricant chamber is connected to the transmission-side bearing and/or the motor-side bearing such that the lubricant can be supplied from the lubricant chamber to the transmission-side bearing and/or the motor-side bearing respectively, and wherein a lubricant seal surrounding the adapter shaft is arranged in each case on the transmission side of the transmission-side bearing and on the motor side of the motor-side bearing for the purpose of sealing the lubricant chamber. The object is further achieved by a method for manufacturing an adapter assembly for connecting a transmission unit to a motor unit, comprising steps as follows: providing a transmission-side adapter with a transmission-side bearing and a motor-side adapter with a motor-side bearing; connecting the transmission-side adapter to the motor-side adapter; mounting an adapter shaft in the bearings such that the adapter shaft is rotatably supported in the bearings; forming at least one lubricant chamber for holding lubricant, said lubricant chamber extending annularly around the adapter shaft and being connected to the transmission-side bearing and/or the motor-side bearing such that the lubricant can be supplied from the lubricant chamber to the transmission-side bearing and/or the motor-side bearing respectively; and arranging a lubricant seal which surrounds the adapter shaft in each case, on both the transmission side of the transmission-side bearing and on the motor side of the motor-side bearing, for the purpose of sealing the at least one lubricant chamber.

The transmission-side adapter is suitable for connecting to a first rotational member, e.g. for attaching to a transmission; the motor-side adapter is suitable for connecting to a second rotational member, e.g. for attaching to a motor. In this case, the adapter may comprise a component, in particular a mounting flange, which can be mounted on, in particular flanged onto, a transmission or a motor. In particular, said component may be an integrally manufactured structural unit, made of e.g. grey cast iron, such as a motor bearing bracket or a coupling skirt.

In the context of the present description, the terms “motor” and “motor unit” are not restricted to a motor, in particular an electric motor, but encompass all drives and drive units for driving a first rotational member such as a transmission, e.g. hydraulic drives, pulleys, couplings, etc. The term “transmission” is equally broad in scope, i.e. it encompasses all rotational members that can be rotationally driven by a second rotational member such as a motor.

The transmission side of a bearing is that side of the bearing which faces a transmission. The expression “motor side” should be understood analogously.

The inventive adapter assembly serves as a connecting element for connecting a motor shaft of a motor unit to a transmission. The inventive adapter assembly has a lubricant chamber, sealed on all sides, for providing lubricant, wherein said lubricant can be supplied from the lubricant chamber, which serves to hold lubricant, to points of friction in the transmission-side bearing or the motor-side bearing. In this case, the lubricant in the lubricant chamber is prevented from escaping from the lubricant chamber by the lubricant seals which surround the adapter shaft, and if applicable by the side plates that are arranged on the inner sides of the bearings.

The invention is based on the idea of allowing the lubricant in the bearings of the adapter assembly to be exchanged or replaced during live operation of the adapter assembly, while the lubricant in the lubricant chamber is being used. This means that the lubricant in the bearings is not always the same, and therefore the lifetime of the lubricant is extended and the maintenance intervals of the adapter assembly increased accordingly. The inventive adapter assembly therefore has considerably longer maintenance intervals than conventional adapter assemblies.

The invention allows simple relubrication of the bearings of the adapter assembly, wherein said relubrication is integrated in the adapter assembly, uses lubricants such as grease, in particular low-viscosity grease, or oil, and is independent of other lubricant sources. The improved lubrication extends the lifetime of the adapter and/or the drive group. The present invention therefore provides a simple means of significantly extending the lifetime of the bearings and consequently increasing the maintenance intervals and reducing the maintenance costs and operating costs.

The invention uses the existing lubricant chamber geometry of a two-part adapter assembly, in order to provide an additional and integrated lubrication facility. The inventive adapter assembly can be realized without costly modifications, or at least without substantial costly modification, to the structural units thereof. It need merely be ensured that lubricant can reach the lubrication points, i.e. the bearings, from the lubricant chamber. To this end, any side plates that are attached as seals on those side faces of the bearing oriented towards the lubricant chamber are removed.

Advantageous embodiments and developments of the invention are derived from the dependent claims. In this case, the inventive method can also be developed in accordance with the dependent device claims, and vice versa.

The lubricant chamber for holding lubricant may be enclosed relative to the exterior, i.e. lubricant which is filled into the lubricant chamber has no way of leaving the lubricant chamber other than via the connections to the transmission-side bearing and/or the motor-side bearing. The lubricant is then protected against harmful influences such as dust and dirt. Lubricant can nonetheless travel from the lubricant chamber to the bearings, where it performs its function of reducing friction, and vice versa; i.e. an exchange of lubricant can take place between the lubricant chamber for holding lubricant and the bearings.

According to a preferred development, the lubricant chamber is separated from a hollow space, which is situated further out radially, by a ring that extends between the transmission-side bearing and the motor-side bearing. The lubricant chamber for holding lubricant therefore has an annular wall, which extends between the transmission-side bearing and the motor-side bearing. This wall forms a radial boundary of the lubricant chamber in which the lubricant is situated. It is therefore possible to prevent lubricant from spreading into spatial regions or hollow spaces which are situated further out radially and in which the lubricant can contribute little or nothing to the relubrication. By virtue of the annular wall which encloses the lubricant chamber, the quantity of lubricant that must be filled into the lubricant chamber can be reduced, since the spread of the lubricant is essentially limited to the surroundings of the bearings.

According to a preferred embodiment, the ring (i.e. the annular wall) is formed by a projection of the motor-side and/or transmission-side adapter. This projection can provide an axial support of the transmission-side bearing, such that the transmission-side bearing is developed as a locating bearing. A gap between the projection and the transmission-side adapter can be sealed against any passage of lubricant, i.e. any unwanted escape of the lubricant from the lubricant chamber, by means of a suitable seal, e.g. an O-ring. The projection and the motor-side adapter can be designed as mutually integral parts.

The annular wall may also be formed by an intermediate ring which is placed between the bearings. The intermediate ring can provide reciprocal axial support of the bearings, wherein the transmission-side bearing preferably takes the form of a locating bearing. Gaps between the intermediate ring and the adapters can be sealed against any passage of lubricant, i.e. any unwanted escape of the lubricant from the lubricant chamber, by means of suitable seals, e.g. by means of O-rings.

According to a preferred embodiment, the lubricant seals surrounding the adapter shaft take the form of a shaft sealing ring in each case, in particular a radial shaft sealing ring with a sealing lip. This can directly abut the adapter or be installed radially within an equalizing ring which in turn abuts the adapter.

According to a preferred embodiment, the adapter assembly comprises at least one channel via which lubricant can be supplied from the surroundings of the adapter assembly to the lubricant chamber and/or via which lubricant can be discharged from the lubricant chamber. This channel can therefore also be referred to as a lubricant transport channel. By “surroundings of the adapter assembly” is meant any lubricant chamber surrounding the adapter assembly. The channel therefore offers a simple means of supplying, from the surroundings of the adapter assembly, i.e. from the exterior, lubricant to the bearings which are arranged within the adapter assembly, without having to open the adapter assembly.

The at least one channel may also run through the motor-side adapter alone, i.e. be arranged in only one component of the adapter assembly. A standard component can therefore be used for the transmission-side adapter, while only the motor-side adapter need be equipped with a channel for the application in the adapter assembly. This simplifies the manufacture of the adapter assembly and supports the use of standardized unmodified components.

One end of the at least one channel may terminate at the motor-side bearing. If the at least one channel runs through the motor-side adapter, the shaft end of the channel advantageously terminates at the motor-side bearing. This means that a standard component can be used for the transmission-side adapter, while only the motor-side adapter need be equipped with a channel for the application in the adapter assembly.

According to a preferred embodiment, the adapter assembly, preferably the motor-side adapter, comprises at least two channels, wherein a first channel of the at least two channels is an inlet channel for supplying lubricant to the lubricant chamber and a second channel of the at least two channels is an outlet channel for discharging lubricant from the lubricant chamber. By virtue of the combined arrangement of an inlet channel and an outlet channel in the adapter assembly, simple exchange of the lubricant in the lubricant chamber is possible. In this case, provision is made for setting a defined oil level in the lubricant chamber by filling a predetermined quantity of oil via the inlet channel while the outlet channel is closed, preferably by means of a sealing plug. In order to change the oil, used oil is drained from the lubricant chamber via the outlet channel and fresh oil is filled into the lubricant chamber via the inlet channel, as when changing the oil in an automobile.

The adapter assembly, preferably the motor-side adapter, can have at least three channels. A first channel of the at least three channels serves as an inlet channel for supplying lubricant to the lubricant chamber. A second channel of the at least three channels serves as an outlet channel for discharging lubricant from the lubricant chamber. A third channel of the at least three channels serves as a setting channel for setting a defined oil level in the lubricant chamber. In this case, a defined oil level in the adapter assembly is set by draining excess oil from the lubricant chamber via at least one setting channel. In this case, the at least one setting channel is arranged such that a predetermined quantity of oil remains in the lubricant chamber at all times, i.e. a defined oil level is guaranteed. In this case, the height of the opening of the at least one setting channel in the lubricant chamber may be such that the oil level is situated at approximately the height of the lower edge of the adapter shaft.

If the adapter assembly has the at least three channels cited above, an oil change can be effected by draining used oil from the lubricant chamber via the outlet channel and filling fresh oil into the lubricant chamber via the inlet channel, as when changing the oil in an automobile. A continuous oil exchange can be effected during operation of the adapter assembly by introducing fresh oil into the lubricant chamber via the inlet channel while the outlet channel is closed, preferably by means of a sealing plug. In this case, excess oil, i.e. oil which has been introduced in excess of the defined oil level, is drained from the lubricant chamber via the at least one setting channel.

The setting channel can be used to divert lubricant from the lubricant chamber into the transmission unit. If this diversion of lubricant via the setting channel is combined with a lubricant feed, preferably via an inlet channel, it is possible to realize a circular lubrication, and preferably integrate this into a lubricant transport circuit of the transmission unit. The term circular lubrication designates a lubricant circuit comprising a reservoir, e.g. an oil well or an oil sump in the transmission unit, a supply from the reservoir to the point of friction, e.g. via the inlet channel, and a return to the reservoir, e.g. via the setting channel. A lubricant preparation or processing means, e.g. an oil filter or an oil cooling device, can also be integrated into the lubricant circuit. Using a circular lubrication, it is usually possible to operate using smaller quantities of oil in the system than are required for separate lubrication of transmission and adapter assembly. A circular lubrication can advantageously be realized using lubricating oil.

The adapter assembly may be an adapter for IEC motors, NEMA motors and servomotors, i.e. allowing the attachment of IEC motors, NEMA motors and servomotors (IEC=International Electrotechnical Commission; NEMA=National Electrical Manufacturers Association). In this case, the adapter assembly may be so configured that various coupling variants can be integrated in the motor-side adapter, e.g. an elastic coupling, a rigid coupling or a slip coupling, and a backstop. However, the motor-side adapter may also be simply embodied to hold the journal of the adapter shaft. This variant has the shortest overall length and is the most economical embodiment.

The adapter assembly may also allow the drive to be provided via a free shaft end. In this case, the motor-side adapter is so embodied as to surround a journal of the adapter shaft. In this embodiment, the rotational moment may be introduced into a transmission using a coupling or pulley which is attached to the free shaft end.

A preferred development of the invention takes the form of a drive group comprising an adapter assembly in one of the embodiments cited above and a transmission unit and/or a motor unit which is/are connected to the adapter assembly.

A further preferred development of the invention takes the form of a modular system for creating an adapter assembly as claimed in one of the claims 1 to 9, comprising a plurality of transmission-side adapters which are suitable for connecting to different transmission units and each have a transmission-side bearing, a plurality of motor-side adapters which can be connected to at least one of the transmission-side adapters in each case and are suitable for connecting to different motor units and each have a motor-side bearing, and adapter shafts which are rotatably supported in the respective bearings.

The different transmission units may comprise transmissions of different sizes. The different motor units may comprise motors of different sizes.

The inventive adapter assembly modular system allows a multiplicity of different adapter variants, all of which ensure reliable transportation of lubricant to the rolling bearings which serve to support the adapter shaft, by forming a lubricant chamber in the interior of the adapter assembly. A significant improvement is thereby achieved relative to conventional adapter systems, in which it is not possible to form a lubricant chamber for holding lubricant in all adapter variants of the modular system. In the context of the inventive adapter assembly system, a motor-side adapter of one size may be combined with different transmission-side adapters or the corresponding transmissions. This is achieved inter alia in that the motor-side adapter of one size and the different transmission-side adapters have a shared interface. In this case, the motor-side interface of the motor-side adapter is adapted to the different motors (different motor types and different sizes within each motor type) and the transmission-side interface of the transmission-side adapter is adapted to the different transmission (different transmission types and different sizes within each transmission type), while the mutually facing interfaces of a motor-side adapter and a corresponding transmission-side adapter are identical (=shared interface).

If a specific number of motor-side adapters are provided for different motor types and motor sizes, each of which can be combined with a plurality of different transmission-side adapters via a shared interface, the required number of parts can be significantly reduced. By virtue of the inventive embodiment of the adapter assembly and the inventive adapter assembly system, it is therefore possible to increase the number of possible combinations of motors and transmissions, particularly if the number of parts is reduced. This means that many combinations of motors and transmissions are possible using modest storage.

According to a preferred embodiment, the method comprises a further step as follows: forming at least one channel via which lubricant can be supplied to the lubricant chamber from the surroundings of the adapter assembly, and/or forming at least one channel via which lubricant can be drained from the lubricant chamber. Once it has been formed, the at least one channel can be closed again by means of an easily removable sealing plug in this case. The adapter assembly therefore offers two different usage possibilities: either the adapter assembly is used in a conventional manner, if the sealing plug is not removed and the channel therefore remains unused; alternatively, the adapter assembly can be relubricated via the channel after the sealing plug has been removed, e.g. by means of pulling.

The at least one channel is preferably formed in the motor-side adapter. In this case, it is advantageous if the at least one channel runs exclusively in the motor-side adapter. This allows a standard adapter to be used as a transmission-side adapter, wherein a standard adapter does not require to be modified in any way for use in the adapter assembly.

The at least one channel is preferably formed by means of a material removing method, in particular drilling or milling.

The motor bearing brackets of the motor units, to which an inventive adapter assembly is connected, do not require modification. All of the characteristics required for the “longer maintenance intervals” option are implemented in the “motor-side adapter” component. The structural features comprise the possibility of installing a lubricant seal for sealing the lubricant chamber, said lubricant seal surrounding the adapter shaft and taking the form of a shaft sealing ring in particular, the design and the possibility of installing a component which radially encloses the lubricant chamber and extends between the transmission-side bearing and the motor-side bearing, in particular taking the form of a projection of the motor-side adapter or an intermediate ring which is placed between the bearings, and furthermore the possibility of incorporating at least one lubricant channel by means of casting, and the associated possibility of incorporating this retrospectively into the cast housing by manufacturing means as an option.

The above described characteristics, features and advantages of the present invention, and the means by which these are achieved, become clearer and easier to understand in the context of the following description of the exemplary embodiments, these being explained in greater detail with reference to the drawings in which:

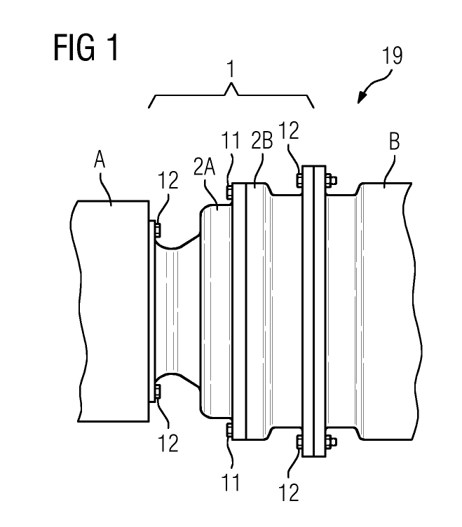

FIG. 1 shows a view of an adapter assembly which is arranged between a transmission unit and a motor unit;

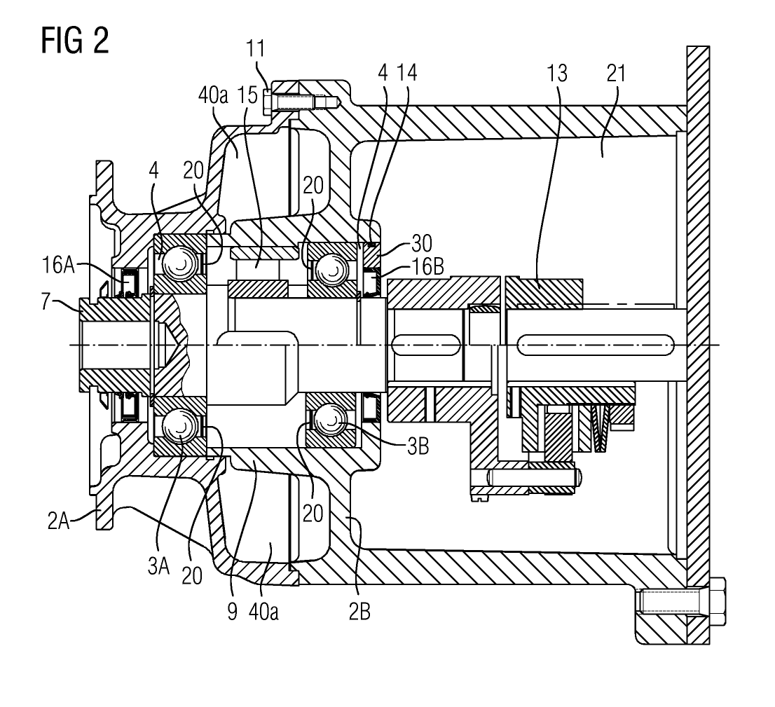

FIG. 2 shows sections of two different exemplary embodiments of an adapter assembly having a first, relatively long structural format;

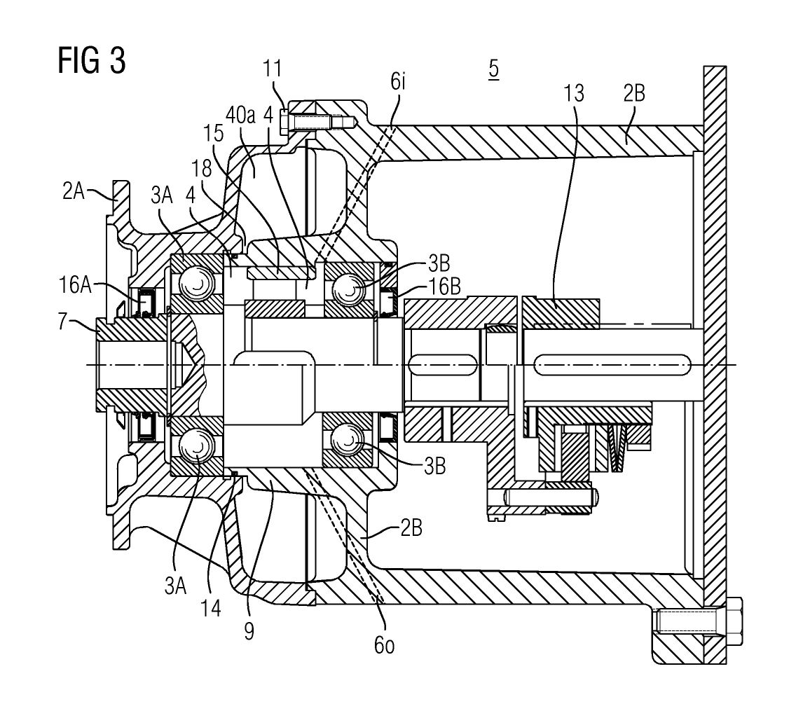

FIG. 3 shows sections of two different exemplary embodiments of an adapter assembly, which are configured similarly to the exemplary embodiments illustrated in FIG. 2, but are however embodied for longer maintenance intervals;

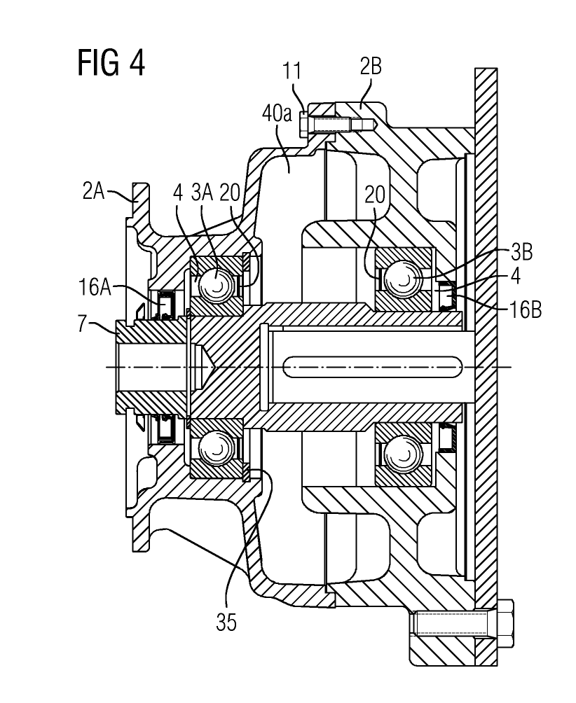

FIG. 4 shows a section of an adapter assembly having a second, relatively short structural format;

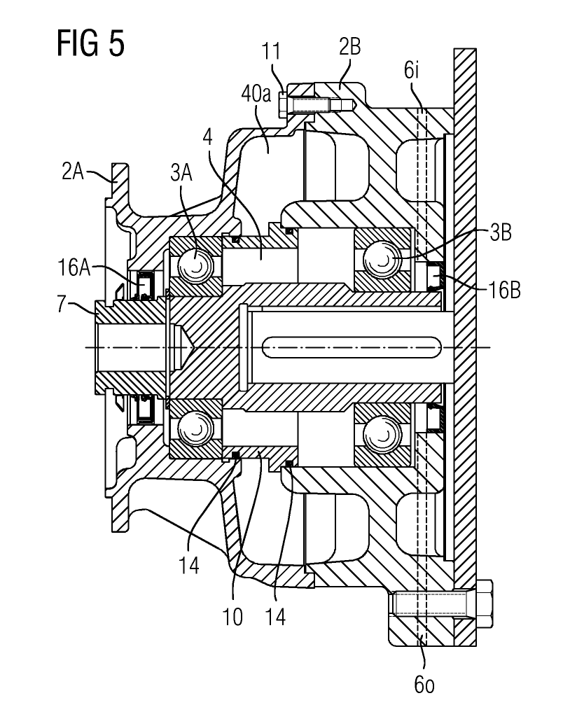

FIG. 5 shows a section of an adapter assembly, which is configured similarly to the exemplary embodiment illustrated in FIG. 4, but is embodied for longer maintenance intervals;

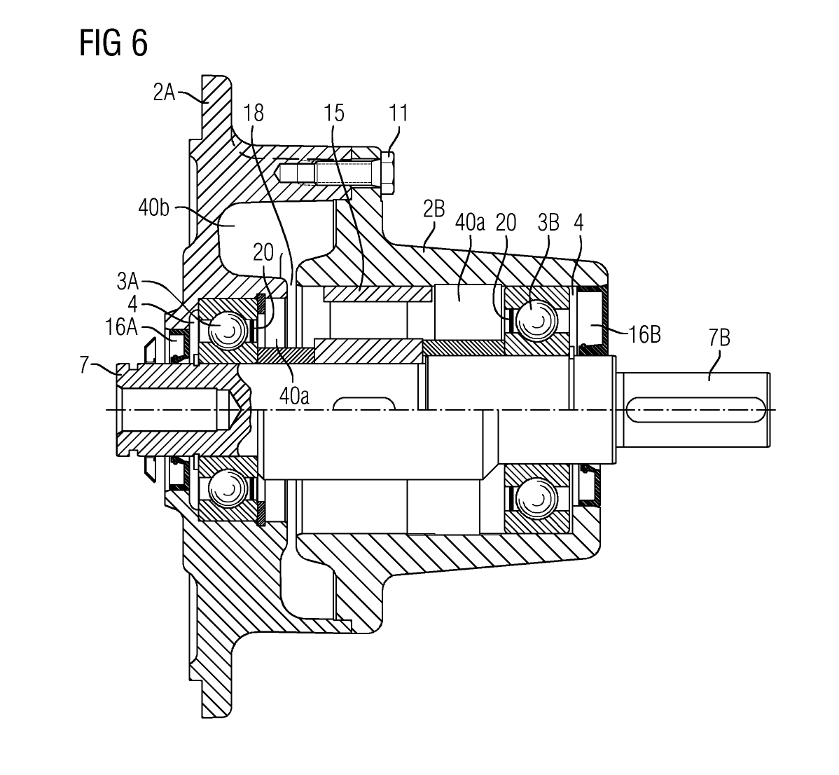

FIG. 6 shows a section of an adapter assembly having a free shaft end;

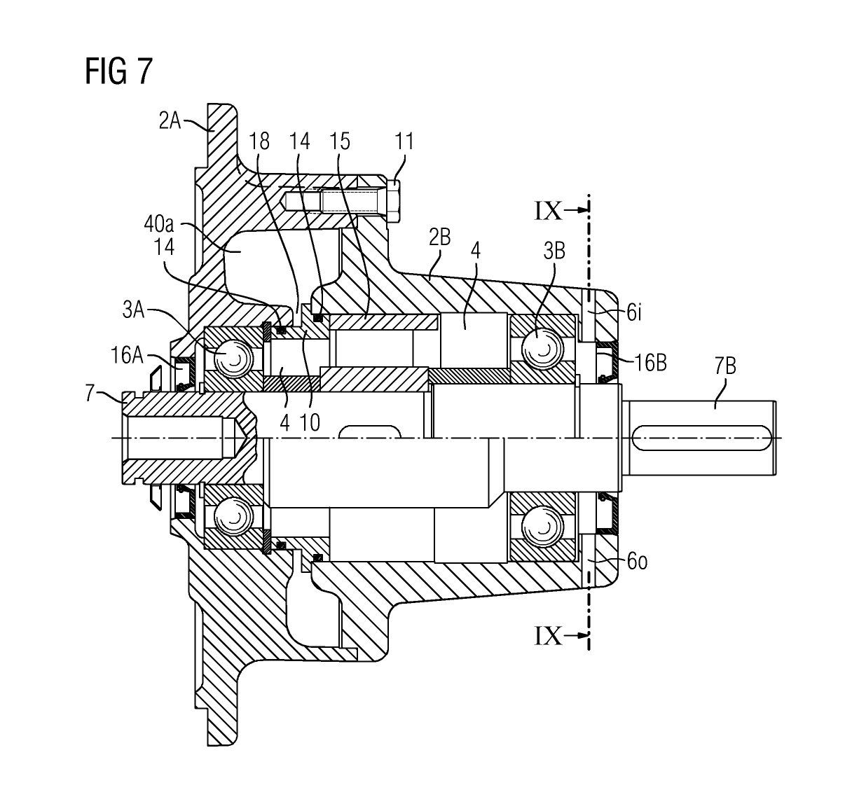

FIG. 7 shows a section of an adapter assembly, which is configured similarly to the exemplary embodiment illustrated in FIG. 6, but is designed for longer maintenance intervals;

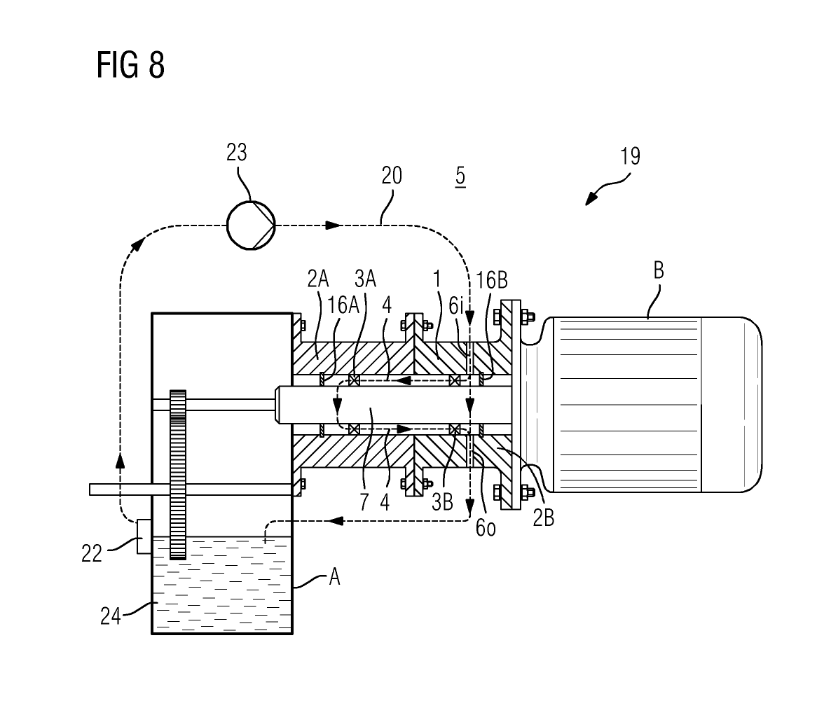

FIG. 8 shows a side view of a drive group, illustrated partially in section, comprising a coupling adapter, a transmission unit and a motor unit; and

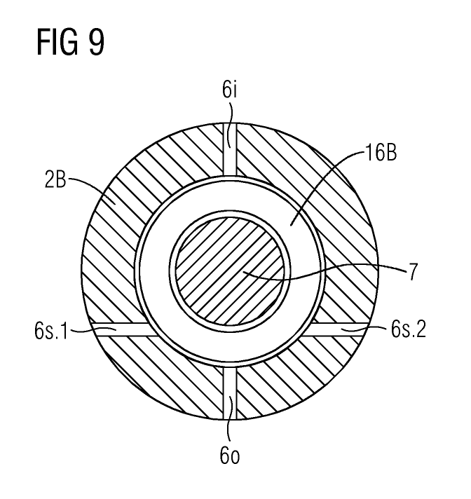

FIG. 9 shows a section IX-IX through the motor-side adapter illustrated in FIG. 7, said section running transversely relative to the shaft axis.

FIG. 1 shows a view of an adapter assembly 1 which is arranged between a transmission unit A and a motor unit B. The motor unit B may be designed as e.g. an electric motor as per the IEC standard for three-phase motors, while the transmission unit A may be e.g. an individually manufactured transmission. The adapter assembly 1 has a transmission-side adapter 2A and a motor-side adapter 2B, these being interconnected by means of connection screws 11. The transmission-side adapter 2A is preferably a standard motor bearing bracket. The motor-side adapter 2B is preferably a standard coupling skirt. The adapters 2A, 2B preferably consist of cast iron, preferably grey cast iron. The adapter assembly 1 is mounted onto the transmission unit A and the motor unit B by means of fixing screws 12 in each case.

FIG. 2 shows sections of two different exemplary embodiments of an adapter assembly having a first, relatively long structural format. Since these exemplary embodiments are suitable for attachment of IEC motors, NEMA motors or servomotors, they are referred to as a “standard embodiment” here. The different embodiment variants relate to the installation of different coupling variants and a backstop. Different embodiments of a motor-side seal using shaft sealing rings are likewise illustrated here. Z-type ball bearings are installed in the adapter assembly for the standard embodiment.

The adapter assembly has a transmission-side adapter 2A and a motor-side adapter 2B, these being securely connected together by means of connection screws 11. Each of the two adapters 2A, 2B comprises a bearing 3A, 3B in each case. The transmission-side bearing 3A is also referred to as the A bearing, and the motor-side bearing 3B as the B bearing. The bearings 3A and 3B may take the form of Z-type deep-groove ball bearings as illustrated in FIG. 2. The suffix Z for rolling bearings indicates that the rolling bearing has a non-rubbing side plate which is usually made of metal plate, preferably steel plate, on one side of the bearing. Such bearings are used when the risk of dirt is slight and the absence of friction is crucial.

The transmission-side bearing 3A is axially braced by the motor-side adapter 2B and is therefore designed as a locating bearing. The motor-side bearing 3B is designed as a non-locating bearing.

In the case of the transmission-side bearing 3A, the side. plate 20 is arranged on the motor side, whereas that side of the transmission-side bearing 3A facing the transmission is so designed as to be open, i.e. without a side plate. In the case of the motor-side bearing 3B, the side plate 20 is arranged on the transmission side, whereas that side of the motor-side bearing 3B facing the motor is so designed as to be open, i.e. without a side plate.

An adapter shaft 7 is rotatably supported in the bearings 3A, 3B and serves to form a non-rotatable connection between a motor unit and a transmission unit which are not shown here. A transmission-side shaft sealing ring 16A is provided on the transmission side of the transmission-side bearing 3A, and a motor-side shaft sealing ring 16B is provided on the motor side of the motor-side bearing 3B. The transmission-side shaft sealing ring 16A seals the adapter assembly relative to the transmission. The motor-side shaft sealing ring 16B seals the adapter assembly relative to the coupling space 21. The shaft sealing rings 16A and 16B are designed as radial shaft sealing rings with sealing lips. The motor-side shaft sealing ring 16B which is installed in the motor-side adapter 2B can directly abut the motor-side adapter 2B (see lower half of FIG. 2), or be located radially within an equalizing ring 30 having a groove along its circumference and an O-ring 14 which is placed therein in order to provide a seal relative to the motor-side adapter 2B (see upper half of FIG. 2).

The lubricant chamber 4 between the transmission-side bearing 3A and the, transmission-side shaft sealing ring 16A, and between the motor-side bearing 3B and the motor-side shaft sealing ring 16B, is in each case filled with a specified quantity of grease for lubricating the bearings 3A, 3B.

The upper half of FIG. 2 shows an exemplary embodiment in which a built-on free wheel 15 is radially arranged as a backstop within a projection 9 of the motor-side adapter 2B between the A and B bearings 3A, 3B, and a coupling 13 is arranged on the adapter shaft 7 in the region of the motor-side adapter 2B. In this case, the coupling can be an elastic coupling which is only used to transfer the rotational moment. The purpose of such a coupling may be to isolate detrimental influences such as axial and/or radial forces, vibrations or axial misalignment.

FIG. 3 shows two different exemplary embodiments of an adapter assembly in the two sectional halves which are separated by the horizontal, dash-dot line, and which are configured in a similar manner to the exemplary embodiments illustrated in FIG. 2 but are designed for longer maintenance intervals. The illustrated adapter assemblies are suitable for attachment of IEC motors, NEMA motors or servomotors. The installation of different coupling variants 13 and a backstop 15 are shown. Different embodiments of a motor-side seal using shaft sealing rings 16B are likewise illustrated.

In the embodiment for longer maintenance intervals, the adapter assembly has ball bearings 3A, 3B of standard design, i.e. without side plates. As a result of installing an O-ring 14 at an inner annular contact point of the adapters 2A, 2B, a closed lubricant chamber 4 for holding the lubricant is formed, said lubricant chamber 4 being separated by the projection 9 from an annular hollow space 40a which is situated further out radially and in which no lubricant is present.

Holes 6i and 6o are incorporated in the motor-side adapter 2B for the purpose of respectively supplying and discharging lubricant into or from the lubricant chamber 4 for holding the lubricant. The supplying hole 6i is positioned at the uppermost point of the motor-side adapter 2B. The draining hole 6o is positioned on the motor-side adapter 2B such that a sufficient quantity of lubricating oil is always available for the rolling bearings 3A, 3B. By virtue of the channels 6i, 6o, lubricant can be supplied to the lubricant chamber 4 from the surroundings 5 of the adapter assembly and/or discharged from the lubricant chamber 4.

Since the lubricant chamber 4, which extends continuously between the two shaft sealing rings 16A, is significantly larger than in the exemplary embodiment with the two separate lubricant chambers 4 as shown in FIG. 2, relatively long maintenance intervals are produced.

FIG. 4 shows a section of an adapter assembly having a short structural format. For the standard embodiment, Z-type ball bearings are installed in the adapter assembly. Both bearings 3A, 3B have side plates 20 on the sides which face each other, but are open, i.e. do not have side plates, on the respective outer sides.

The transmission-side bearing 3A is held in place by a retaining ring 35 and therefore designed as a locating bearing. The motor-side bearing 3B is a non-locating bearing.

A transmission-side shaft sealing ring 16A is provided on the transmission side of the transmission-side bearing 3A, and a motor-side shaft sealing ring 16B is provided on the motor side of the motor-side bearing 3B. The transmission-side shaft sealing ring 16A seals the adapter assembly relative to the transmission. The motor-side shaft sealing ring 16B seals the adapter assembly relative to the motor.

The lubricant chamber 4 between the transmission-side bearing 3A and the transmission-side shaft sealing ring 16A, and between the motor-side bearing 3B and the motor-side shaft sealing ring 16B, is in each case filled with a specified quantity of grease for lubricating the bearings 3A, 3B. A hollow space 40a, in which there is no lubricant, is situated between the bearings 3A, 3B and surrounds the adapter shaft 7.

FIG. 5 shows a section of an adapter assembly having a short structural format in an embodiment for longer maintenance intervals. For this embodiment, ball bearings 3A, 3B without side plates are installed in the adapter assembly. The lubricant chamber 4 for holding the lubricant is separated by the installation of an intermediate ring 10 and by O-rings 14 from a lubricant chamber 40a which is situated further out radially and in which no lubricant is present. Holes 6 are incorporated in the motor-side adapter 2B for the purpose of respectively supplying and discharging lubricant into or from the lubricant chamber 4 for holding the lubricant.

The transmission-side bearing 3A is fixed and therefore designed as a locating bearing. The motor-side bearing 3B is a non-locating bearing. The intermediate ring 10 abuts the transmission-side bearing 3A with a transmission-side end face, and abuts the motor-side adapter 2B with a rib which projects from the circumference of the ring 10 and is disposed on the motor-side end thereof. The intermediate ring 10 has at its circumference two grooves with O-rings located therein, specifically a groove facing an annular surface of the transmission-side adapter 2A and a groove facing an annular surface of the motor-side adapter 2A, thereby forming a lubricant seal of the lubricant chamber 4 relative to the hollow space 40a which is situated further out radially.

FIG. 6 shows a section of an adapter assembly having a free shaft end 7B of the adapter shaft 7. The installation of a backstop 15 is illustrated in the upper half of the drawing. Also illustrated is the different embodiment of the motor-side seal using a shaft sealing ring 16.

Both bearings 3A, 3B have side plates 20 on the sides which face each other, but are without side plates, i.e. open, on their respective outer sides.

A transmission-side shaft sealing ring 16A is provided on the transmission side of the transmission-side bearing 3A, and a motor-side shaft sealing ring 16B is provided on the motor side of the motor-side bearing 3B. The transmission-side shaft sealing ring 16A seals the adapter assembly relative to the transmission. The motor-side shaft sealing ring 16B seals the adapter assembly relative to the surroundings.

The lubricant chamber 4 between the transmission-side bearing 3A and the transmission-side shaft sealing ring 16A, and between the motor-side bearing 3B and the motor-side shaft sealing ring 16B, is in each case filled with a specified quantity of grease for lubricating the bearings 3A, 3B. A hollow space 40a, in which there is no lubricant, is situated between the bearings 3A, 3B and surrounds the adapter shaft 7. This hollow space 40a is connected via a gap 18 to a second hollow space 40b, in which there is likewise no lubricant.

FIG. 7 shows a section of an adapter assembly having a free shaft end 7B of the adapter shaft 7, similar to the adapter assembly illustrated in FIG. 6, but in an embodiment for longer maintenance intervals. The installation of a backstop 15 acting on the adapter shaft 7 is illustrated in the upper half of the FIG. 7, while the adapter assembly without a backstop is illustrated in the lower half. It can also be seen that the lubricant chamber 4 for holding the lubricant is sealed on the motor-side and transmission-side by means of shaft sealing rings 16A and 16B, which therefore form the axial boundaries of the lubricant chamber 4 for holding the lubricant. In both variants (in the upper and lower halves), the bearings 3A, 3B, which are open on both sides, are arranged in the respective end sections of the lubricant chamber 4 for holding the lubricant.

In the upper and lower halves of FIG. 7, the annular lubricant chamber 4 for holding the lubricant is delimited radially inwards by the adapter shaft 7. The lubricant chamber 4 is delimited radially outwards by an intermediate ring 10 which surrounds the adapter shaft 7 and abuts the adapters 2A, 2B, wherein the intermediate ring 10 sits between a bearing outer ring of the transmission-side bearing 3A and the shoulder of the motor-side adapter 2B. An O-ring is used in each case between the intermediate ring 10 and an adapter 2A, 2B for the purpose of sealing the intermediate ring 10 relative to the adapters 2A, 2B.

A hollow space 40a, in which there is no lubricant, is formed radially outside the intermediate ring 10 in both variants. Two holes 6i and 6o are formed in the motor-side adapter 2B, respectively for supplying lubricant to and discharging lubricant from the lubricant chamber 4 for holding the lubricant.

FIG. 8 shows a side view of a drive group 19, illustrated partially in section, comprising a transmission unit A, a motor unit B and, arranged between the transmission A and the motor B, an adapter assembly 1 for the purpose of coupling motor B and transmission A. The adapter assembly 1 comprises two interconnected adapters 2A, 2B, along whose coaxial longitudinal axis an adapter shaft 7 is rotatably supported, said adapter shaft 7 being arranged in a transmission-side bearing 3A and a motor-side bearing 3B. On the transmission side of the transmission-side bearing 3A, the adapter shaft 7 is sealed against penetration of lubricant by means of a shaft sealing ring 16A. A motor-side seal is effected analogously by means of a motor-side shaft sealing ring 16B. A lubricant chamber 4 which annularly surrounds the adapter shaft 7, and within which the transmission-side bearing 3A and the motor-side bearing 3B are arranged, is therefore formed between the two shaft sealing rings 16A, 16B.

An inlet channel 6i for supplying lubricant from an external environment 5 of the drive group 19 to the lubricant chamber 4 is formed in the motor-side adapter 2B, wherein the inlet channel 6i opens into the lubricant chamber 4 between the motor-side shaft sealing ring 16B and the motor-side bearing 3B. An outlet channel 6o for draining lubricant from the lubricant chamber 4 to the external environment 5 of the drive group 19 is also formed in the motor-side adapter 28. The outlet channel 6o leaves the lubricant chamber 4 between the motor-side shaft sealing ring 16B and the motor-side bearing 3B and emerges outside the housing of the motor-side adapter 2B.

Lubricating oil is drained via the outlet channel 6o from the lubricant chamber 4 for holding lubricant, said lubricant chamber surrounding the adapter shaft 7 and being connected to the bearings 3A, 3B, and diverted into the transmission unit A via an oil line running outside the adapter assembly 1. The oil collects there in an oil sump 24, travels from there by means of e.g. splash-type lubrication to an oil outlet in the housing wall of the transmission housing, and from there to an oil filter 22. The oil is conveyed outside the drive group 19 from the oil filter 22 to the inlet channel 6i, e.g. by means of an oil pump 23 that is preferably driven by a transmission shaft, via an external oil line 20 in which the oil can release heat to the surroundings. The filtered and cooled oil arrives in the lubricant chamber 4 again via the inlet channel 6i.

It is thereby possible to realize a circular lubrication, which can preferably be integrated into a lubricant transport circuit of the transmission unit A. In this case, the term circular lubrication refers to a lubricant circuit comprising a reservoir, e.g. an oil well or an oil sump 24 in the transmission unit A, a lubricant supply, e.g. via the inlet channel 6i, to the lubrication points of the adapter assembly 1, in particular the bearings 3A and 3B of the adapter shaft 7, and a return of the lubricant to the reservoir, e.g. the diversion of lubricant from the coupling adapter assembly 1 via the outlet channel 6o.

As an alternative to the exemplary embodiment illustrated in FIG. 8, one of the two channels 6i, 6o may be arranged in the motor-side adapter 2B and the other of the two channels 6i, 6o in the transmission-side adapter 2A; e.g. the outlet channel 6o may be arranged in the transmission-side adapter 2A and open directly into the transmission. A. Similarly, all other conceivable arrangements of the channels in the transmission-side and motor-side adapters 2A, 2B are also possible.

FIG. 9 shows a shows a section IX-IX through the motor-side adapter illustrated in FIG. 7, said section running transversely relative to the shaft axis. The motor-side adapter has four channels. A first vertical channel 6i passes through the housing wall above the shaft 7 and serves as an inlet channel for supplying lubricant to the lubricant chamber. A second vertical channel 6o passes through the housing wall below the shaft 7 and serves as an outlet channel for discharging lubricant from the lubricant chamber. A third and fourth channel 6s.1 and 6s.2 pass through the housing wall horizontally in each case; these two horizontal channels 6s.1 and 6s.2 serve as setting channels for setting a defined oil level in the lubricant chamber. In this case, a setting of a defined oil level in the adapter assembly is effected by draining excess oil from the lubricant chamber through the setting channels 6s.1 and 6s.2. In this case, the setting channels 6s.1 and 6s.2 are arranged such that a predetermined quantity of oil remains in the lubricant chamber at all times, i.e. a defined oil level is guaranteed. To this end, the height of the openings of the setting channels 6s.1 and 6s.2 in the lubricant chamber is such that the oil level is situated at approximately the height of the lower edge of the adapter shaft when the outlet channel 6o is closed.

1.-14. (canceled)

15. An adapter assembly for connecting a transmission unit to a motor unit, comprising
a transmission-side adapter having a transmission-side bearing,
a motor-side adapter having a motor-side bearing and being connected to the transmission-side adapter,
an adapter shaft which is rotatably supported in both the transmission-side bearing and the motor-side bearing,
at least one lubricant chamber which extends annularly around the adapter shaft and is configured to hold a lubricant and is connected to the transmission-side bearing or the motor-side bearing, or both, so as to supply the lubricant from the lubricant chamber to the transmission-side bearing or the motor-side bearing, or both,
a lubricant seal surrounding the adapter shaft and disposed on the transmission side of the transmission-side bearing and on the motor side of the motor-side bearing for sealing the lubricant chamber, and
at least one first channel configured to supply the lubricant from a surroundings of the adapter assembly to the lubricant chamber, or at least one second channel configured to discharge the lubricant from the lubricant chamber, or both the first channel and the second channel, wherein the first and second channels run through only the motor-side adapter.

16. The adapter assembly of claim 15, wherein the lubricant chamber is separated by a ring from a hollow space disposed further radially outwardly, with the ring extending between the transmission-side bearing and the motor-side bearing.

17. The adapter assembly of claim 16, wherein the ring is formed by a projection of the motor-side adapter or the transmission-side adapter, or both, or by an intermediate ring disposed between the transmission-side bearing and the motor-side bearing.

18. The adapter assembly of claim 15, wherein the lubricant seal is constructed as a shaft sealing ring.

19. The adapter assembly of claim 15, wherein one end of the at least one first channel or the at least one second channel terminates at the motor-side bearing.

20. The adapter assembly of claim 15, further comprising a third channel for setting a defined oil level in the lubricant chamber.

21. The adapter assembly of claim 15, wherein the adapter assembly is an adapter for IEC motors, NEMA motors and servomotors.

22. A drive group comprising:
a transmission unit,
a motor unit, and
an adapter assembly comprising
a transmission-side adapter having a transmission-side bearing connected to the transmission unit,
a motor-side adapter having a motor-side bearing and being connected to the a motor unit and to the transmission-side adapter,
an adapter shaft which is rotatably supported in both the transmission-side bearing and the motor-side bearing,
at least one lubricant chamber which extends annularly around the adapter shaft and is configured to hold a lubricant and is connected to the transmission-side bearing or the motor-side bearing, or both, so as to supply the lubricant from the lubricant chamber to the transmission-side bearing or the motor-side bearing, or both,
a lubricant seal surrounding the adapter shaft and disposed on the transmission side of the transmission-side bearing and on the motor side of the motor-side bearing for sealing the lubricant chamber, and
at least one first channel configured to supply the lubricant from a surroundings of the adapter assembly to the lubricant chamber, or at least one second channel configured to discharge the lubricant from the lubricant chamber, or both the first channel and the second channel, wherein the first and second channels run through only the motor-side adapter.

23. A modular system for constructing an adapter assembly, comprising
a plurality of transmission-side adapters connectable to different transmission units, with each transmission-side adapter having a transmission-side bearing,
a plurality of motor-side adapters connectable to at least one of the transmission-side adapters and to different motor units, with each motor-side adapter having a motor-side bearing, and
adapter shafts rotatably supported in the respective transmission-side bearing and motor-side bearings,
wherein the or each adapter assembly comprises
at least one lubricant chamber which extends annularly around the adapter shaft and is configured to hold a lubricant and is connected to the transmission-side bearing or the motor-side bearing, or both, so as to supply the lubricant from the lubricant chamber to the transmission-side bearing or the motor-side bearing, or both,
a lubricant seal surrounding the adapter shaft and disposed on the transmission side of the transmission-side bearing and on the motor side of the motor-side bearing for sealing the lubricant chamber, and
at least one first channel configured to supply the lubricant from a surroundings of the adapter assembly to the lubricant chamber, or at least one second channel configured to discharge the lubricant from the lubricant chamber, or both the first channel and the second channel, wherein the first and second channels run through only the motor-side adapter.

24. A method for manufacturing an adapter assembly for connecting a transmission unit to a motor unit, comprising:
providing a transmission-side adapter with a transmission-side bearing and a motor-side adapter with a motor-side bearing;
connecting the transmission-side adapter to the motor-side adapter;
mounting an adapter shaft in the transmission-side bearing and the motor-side bearing such that the adapter shaft is rotatably supported in the transmission-side bearing and the motor-side bearing;
forming at least one lubricant chamber for holding lubricant, said lubricant chamber extending annularly around the adapter shaft and being connected to at least one of the transmission-side bearing and the motor-side bearing, enabling the lubricant to be supplied from the lubricant chamber to the transmission-side bearing and the motor-side bearing, respectively;
forming at least one first channel configured to supply the lubricant to the lubricant chamber from a surroundings of the adapter assembly, or forming at least one second channel configured to drain the lubricant from the lubricant chamber, or both, wherein the first and second channels run through only the motor-side adapter, and
arranging a lubricant seal, which surrounds the adapter shaft, on both the transmission side of the transmission-side bearing and on the motor side of the motor-side bearing, for sealing the lubricant chamber.
